(19) United States
(12) Patent Application Publication
(10) Pub. No.: US 2026/0110949 A1
(43) Pub. Date: Apr. 23, 2026

(54) SYSTEM, LENS APPARATUS, AND APPARATUS

(71) Applicant: CANON KABUSHIKI KAISHA, Tokyo (JP)

(72) Inventors: KOYA KOBAYASHI, Tokyo (JP); MAKOTO NAKAHARA, Tochigi (JP)

(21) Appl. No.: 19/351,868

(22) Filed: Oct. 7, 2025

(30) Foreign Application Priority Data
Oct. 17, 2024 (JP) 2024-181943

(51) Int. Cl. G03B 13/34

(52) U.S. Cl. CPC G03B 13/34

(57) ABSTRACT

A system includes a first lens apparatus and a second lens apparatus each having a half angle of view exceeding 90° corresponding to a maximum image height in focusing at infinity at a wide-angle end, and a first imaging apparatus that includes a first element configured to receive light of an image formed by the first lens apparatus. The system includes an overlapping range where image-pickup areas of the first lens apparatus and the second lens apparatus overlap with each other. The first imaging apparatus determines a condition of the first imaging apparatus based on information in the overlapping range.

### BACKGROUND

### Field of the Technology

The aspect of the embodiments relates to an imaging system, and the disclosure is suitable for an imaging system that uses an imaging apparatus using a solid-state image sensor, such as a digital still camera, a video camera, a broadcast camera, a surveillance camera, an on-vehicle camera, and the like, or an imaging apparatus, such as a silver halide photographic film camera.

### Description of the Related Art

In imaging methods such as cross reality (XR) imaging represented by virtual reality (VR), mixed reality (MR), and the like and 360° all-around imaging, a combination of a plurality of lens apparatuses is commonly used. In such an imaging method, a wide-viewing-angle optical system, such as a fisheye lens, is used, and Japanese Patent Laid-Open No. 2024-052502 describes an imaging system that can perform VR imaging using two wide-viewing-angle optical systems.

### SUMMARY

According to an aspect of the embodiments, a system includes a first lens apparatus and a second lens apparatus each having a half angle of view exceeding 90° corresponding to a maximum image height in focusing at infinity at a wide-angle end, and a first imaging apparatus that includes a first element configured to receive light of an image formed by the first lens apparatus. The system includes an overlapping range where image-pickup areas of the first lens apparatus and the second lens apparatus overlap with each other. The first imaging apparatus determines a condition of the first imaging apparatus based on information in the overlapping range.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of a lens apparatus according to a first embodiment.

FIGS. 2A to 2C are aberration diagrams of the lens apparatus according to the first embodiment.

FIG. 3 is a cross-sectional view of a lens apparatus according to a second embodiment.

FIGS. 4A to 4C are aberration diagrams of the lens apparatus according to the second embodiment.

FIG. 5 is a cross-sectional view of a lens apparatus according to a third embodiment.

FIGS. 6A to 6C are aberration diagrams of the lens apparatus according to the third embodiment.

FIG. 7 is a cross-sectional view of a lens apparatus according to a fourth embodiment.

FIGS. 8A to 8C are aberration diagrams of the lens apparatus according to the fourth embodiment.

FIG. 9 is a cross-sectional view of a lens apparatus according to a fifth embodiment.

FIGS. 10A to 10C are aberration diagrams of the lens apparatus according to the fifth embodiment.

FIG. 11 is a cross-sectional view of a lens apparatus according to a sixth embodiment.

FIGS. 12A to 12C are aberration diagrams of the lens apparatus according to the sixth embodiment.

FIG. 13 is a schematic diagram of an imaging apparatus.

FIG. 14 is a schematic diagram of an electrical configuration of the lens apparatus according to first to sixth embodiments.

FIG. 15 is a schematic diagram of an electrical configuration of the imaging apparatus.

FIG. 16 is a top view related to an image-pickup area of the imaging apparatus.

FIG. 17 is a top view of an imaging system.

FIG. 18 is a flowchart of each processing in the imaging system.

FIG. 19 is a schematic diagram of a focusing processing method.

FIG. 20 is a schematic diagram of an imaging processing method.

FIG. 21 is a top view of an imaging system according to a modification.

### DESCRIPTION OF THE EMBODIMENTS

Various embodiments according to the present specification will be described in detail below with reference to the attached drawings. Each drawing may be drawn at a different scale from an actual size for the sake of convenience. The same components are denoted by the same reference numerals in each drawing, and redundant description is omitted.

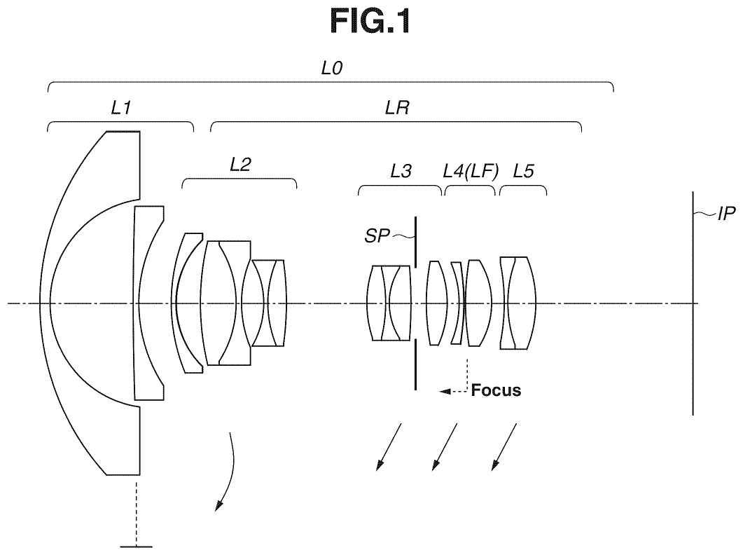

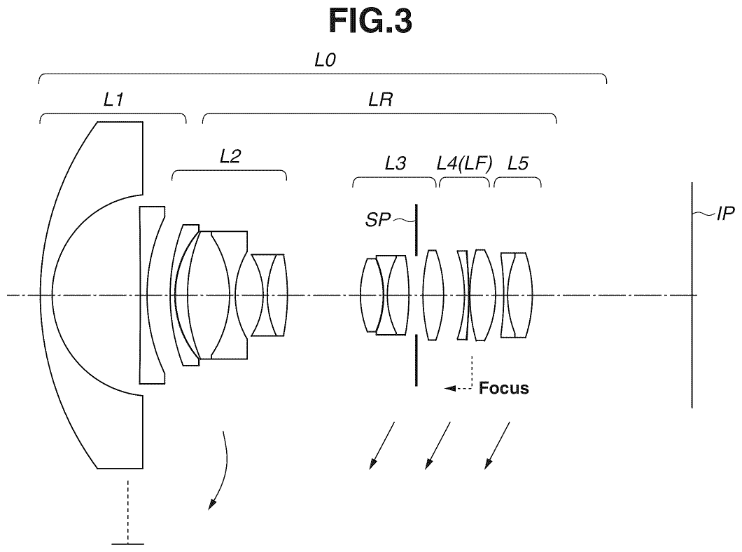

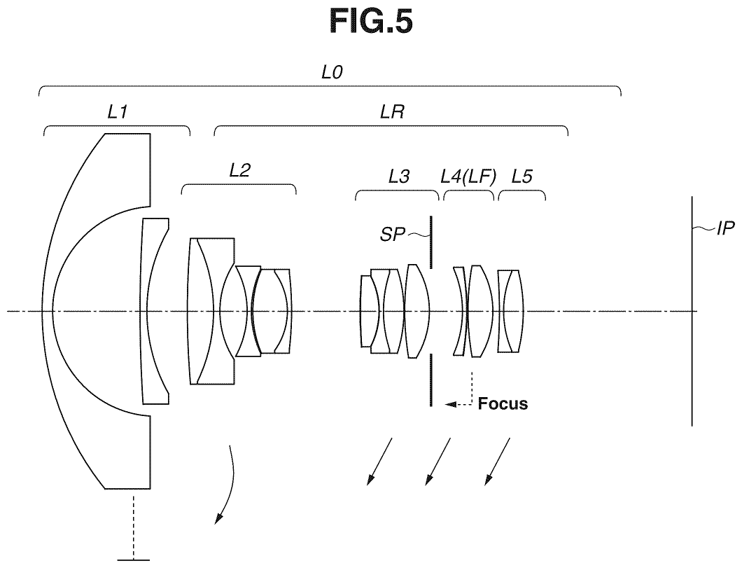

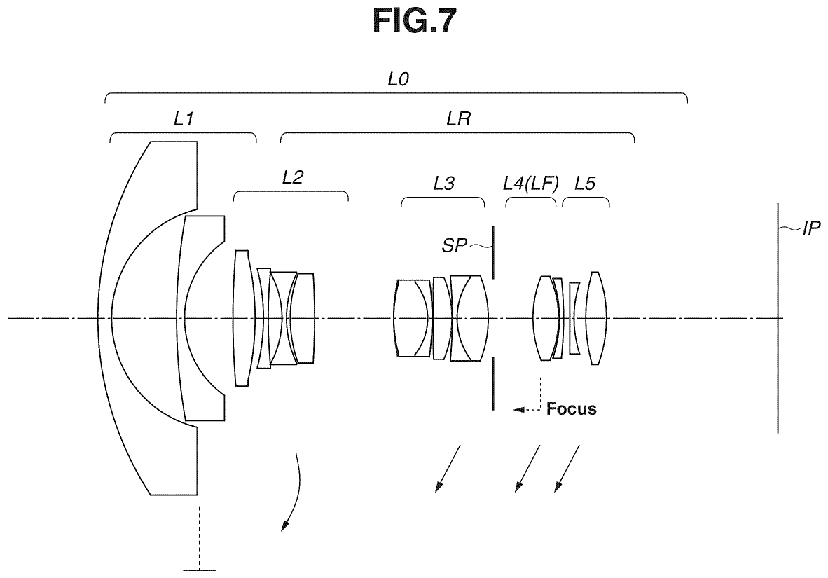

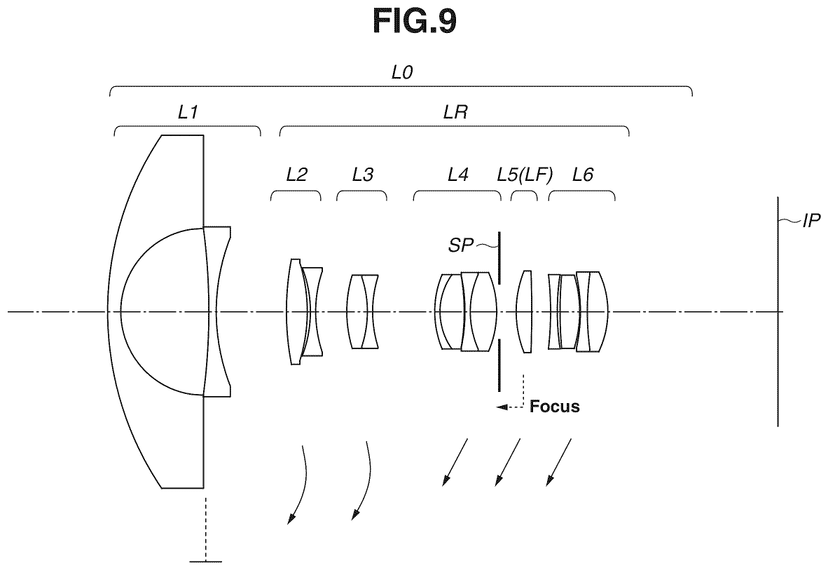

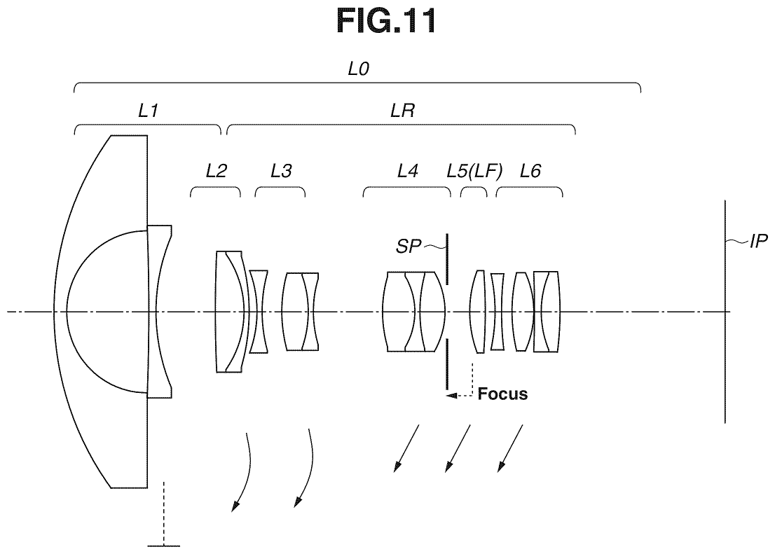

FIGS. 1, 3, 5, 7, 9, and 11 are cross-sectional views of a lens apparatus L0 according to first to sixth embodiments at a wide-angle end in a state where it focuses at infinity. The lens apparatus L0 according to each embodiment is used in an imaging apparatus, such as a digital video camera, a digital still camera, a broadcast camera, a silver-halide film camera, a surveillance camera, and the like, and an optical apparatus including an interchangeable lens. In each cross-sectional view, the left is an object side, and the right is an image side.

The lens apparatus L0 according to each embodiment is configured with a plurality of lens units. A lens unit in the present specification refers to a group of one or more lenses that move together in zooming. In the lens apparatus L0 according to each embodiment, a distance between adjacent lens units changes in zooming from the wide-angle end to a telephoto end.

In each cross-sectional view, a lens unit L1 refers to an i-th lens unit (i is a natural number) counted from the object side among the lens units included in the lens apparatus L0. A rear unit LR includes all lenses and lens units arranged closer to the image side than a first lens unit L1.

In each cross-sectional view, an aperture stop is referred to as SP. In each cross-sectional view, an image plane is referred to as IP, and in a case where the lens apparatus L0 according to each embodiment is used as an imaging optical system for a digital still camera or a digital video camera, an imaging plane ∞ f a solid-state image sensor, such as a charge coupled device (CCD) sensor, or a photoelectric conversion element, such as a complementary metal oxide semiconductor (CMOS) sensor, is arranged on the image plane IP. In a case where the lens apparatus L0 according to each embodiment is used as an imaging optical system for a silver-halide film camera, a photosensitive surface corresponding to a film surface is arranged on the image plane IP.

Solid line arrows in each lens cross-sectional view indicate a movement locus of each lens unit in zooming from the wide-angle end to the telephoto end in a simplified manner. The wide-angle end and the telephoto end in the present specification refer to respective zoom positions in a case where each lens unit is located at both ends of a movable range on an optical axis. A dashed line arrow in each lens cross-sectional view also indicates a movement locus of a focusing unit LF that moves toward the image plane IP in focusing from infinity to a close distance in a simplified manner.

The lens apparatus L0 according to each embodiment includes the first lens unit L1 having a negative refractive power and the rear unit LR including one or more lens units, which are arranged in order from the object side to the image side. The rear unit LR includes all lens units that are arranged closer to the image side than the first lens unit L1. In the lens apparatus L0 according to each embodiment, an optical member having substantially no refractive power, such as a low-pass filter and an infrared cut filter, can also be arranged between the lens arranged closest to the image and the imaging plane.

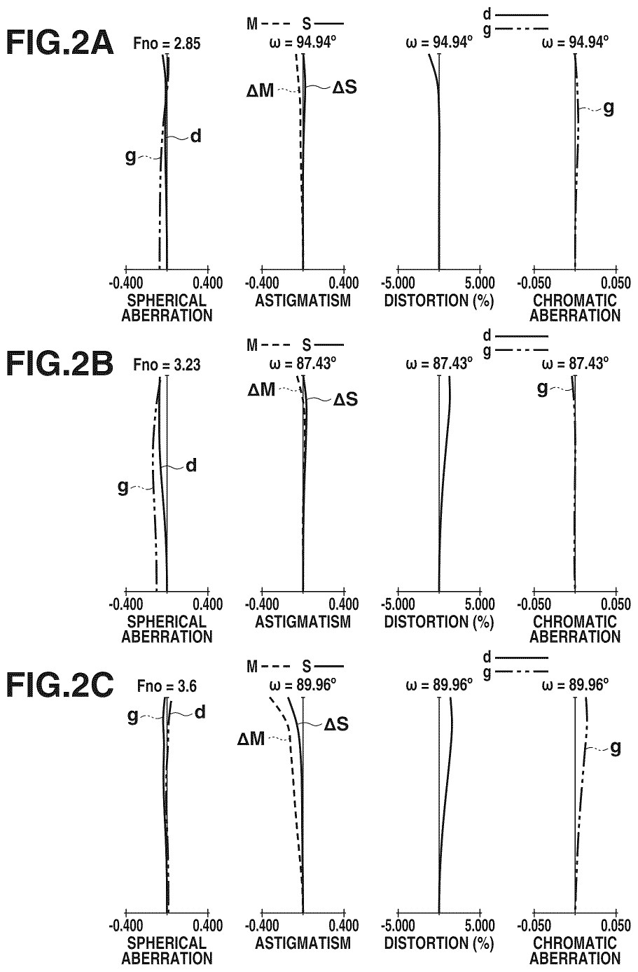

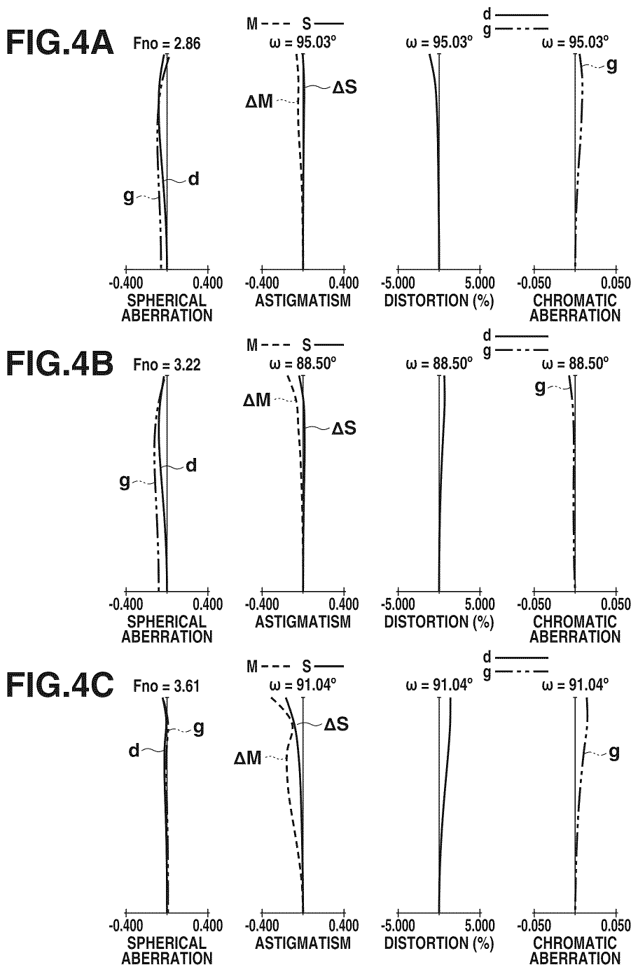

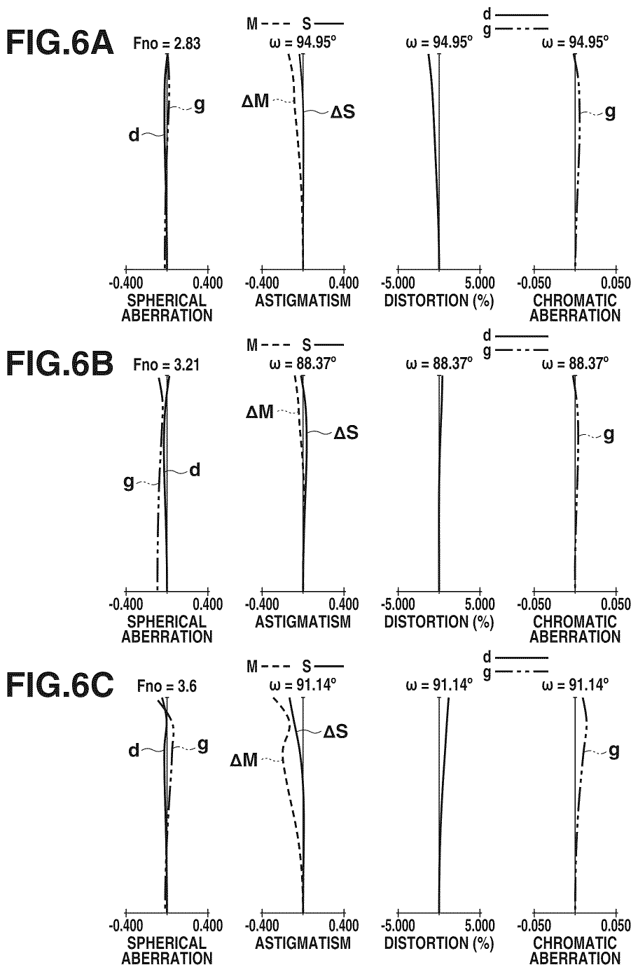

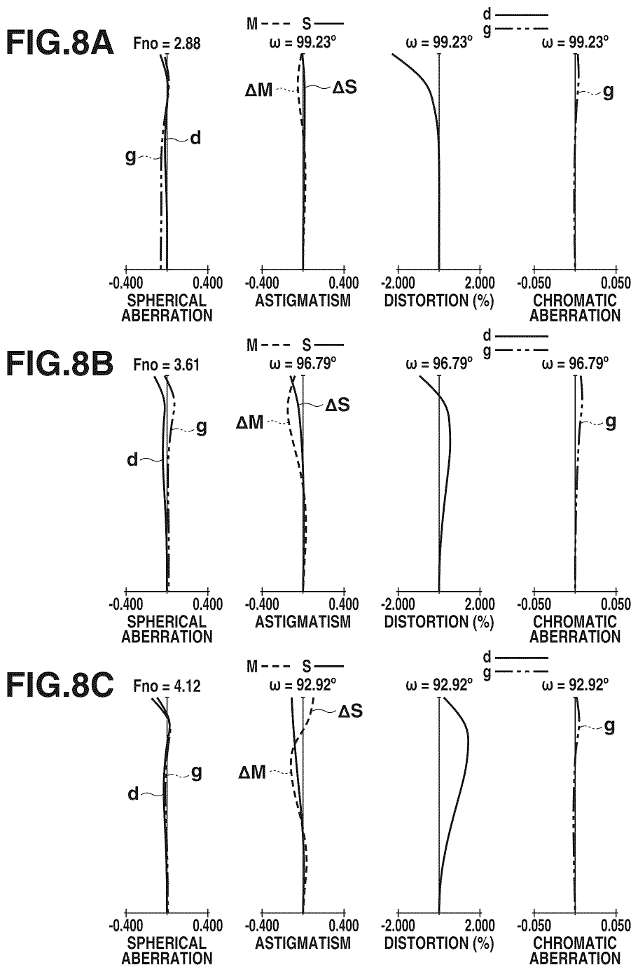

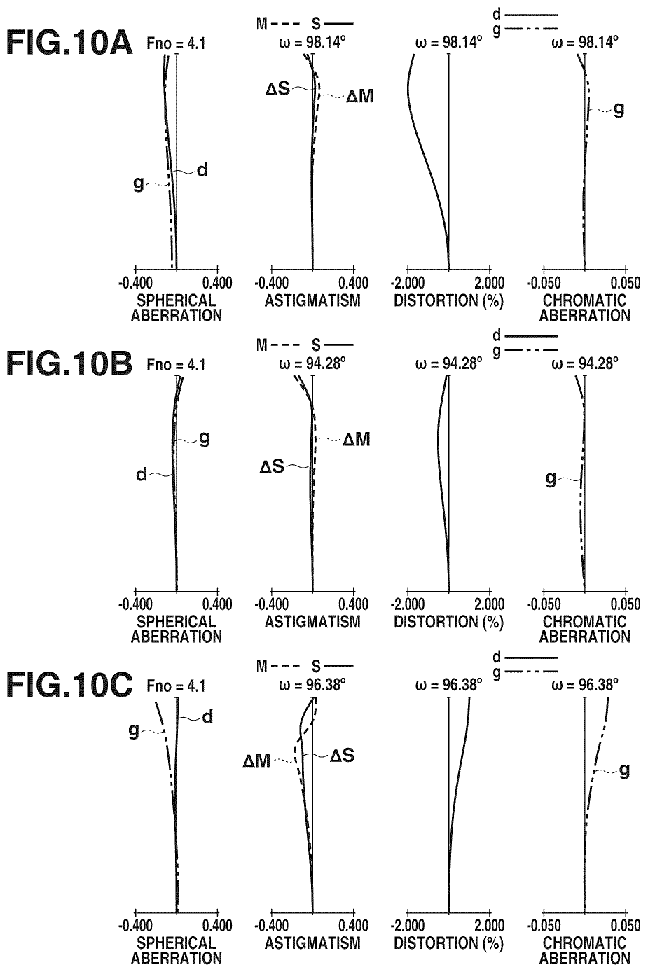

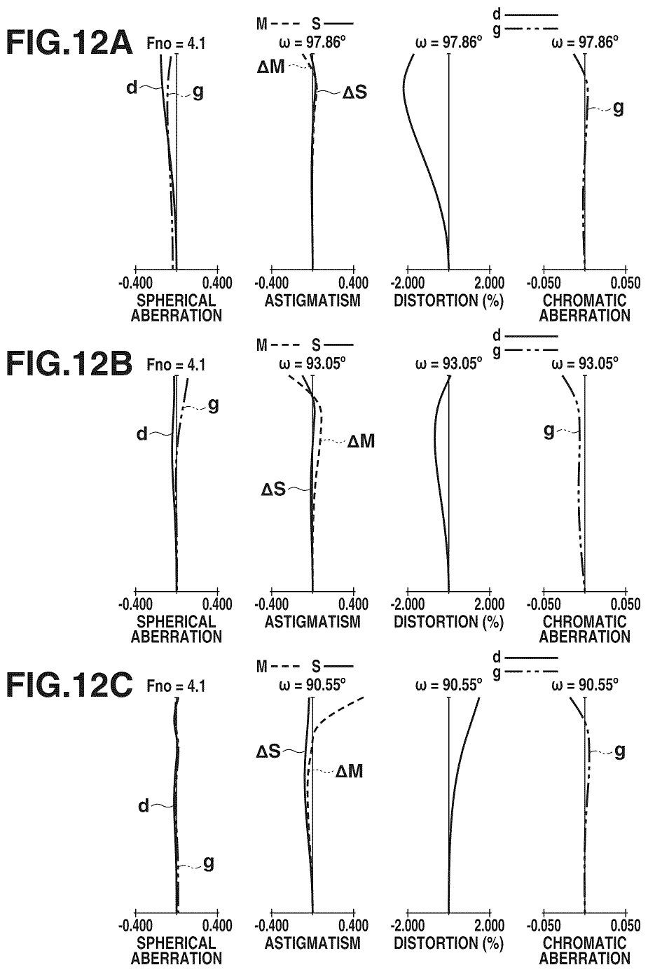

FIGS. 2A to 2C, 4A to 4C, 6A to 6C, 8A to 8C, 10A to 10C, and 12A to 12C are aberration diagrams of the lens apparatus L0 according to the first to sixth embodiments.

Each aberration diagram illustrates an aberration of each embodiment when focused at infinity. Figures with branch numbers A, B, and C are the aberration at the wide-angle end, aberration at an intermediate zoom position, and aberration at the telephoto end, respectively.

In a spherical aberration diagram, Fno represents an F-number, a solid line indicates an amount of spherical aberration for a d-line (wavelength 587.6 nm), a double-dashed line indicates an amount of spherical aberration for a g-line (wavelength 435.8 nm). In an astigmatism diagram, ΔS indicates an amount of astigmatism on a sagittal image plane, and ΔM indicates an amount of astigmatism on a meridional image plane. In a distortion aberration diagram, a solid line indicates an amount of distortion aberration for the d-line. In a chromatic aberration diagram, a double-dashed line indicates an amount of chromatic aberration for the g-line. In each aberration diagram, ω is an imaging half angle of view (°), which is an angle of view calculated by paraxial calculation.

In the lens apparatus L0 according to each embodiment, an isometric projection method expressed by a formula Y=f·θ is adopted as a projection method in the first to third embodiments. In the fourth to sixth embodiments, an equisolid angle projection method expressed by a formula Y=2·f·sin(θ/2) is adopted as a projection method. In the formulae, f represents a focal length of the entire system of the lens apparatus L0, and θ represents an incident angle of a light beam. In the lens apparatus L0 according to each embodiment, the projection method is not limited to the isometric projection method or the equisolid angle projection method, and other projection methods can also be used.

Next, an electrical configuration common to the lens apparatuses L0 according to the present embodiments will be described.

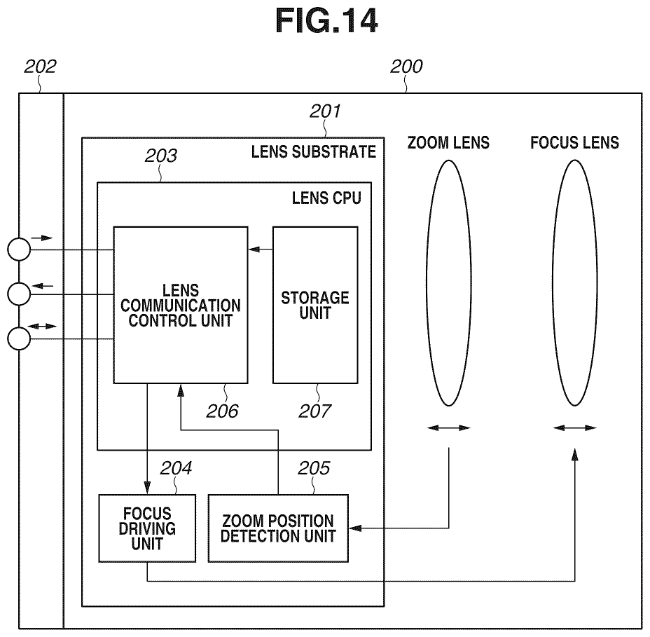

FIG. 14 is a schematic diagram of an electrical configuration of a lens apparatus 200 according to the present embodiment.

The lens apparatus 200 includes a lens substrate 201 and a lens mount 202. The lens mount 202 can be detachably attached to an imaging apparatus. The lens apparatus 200 has the same configuration as that of the lens apparatus L0 described above.

The lens substrate 201 includes a lens central processing unit (CPU) 203, a focus driving unit 204, and a zoom position detection unit 205. The focus driving unit 204 drives a focus lens to perform focusing.

The zoom position detection unit 205 detects a current zoom position of the lens apparatus 200.

The lens CPU 203 includes a lens communication control unit 206 and a storage unit 207.

The lens communication control unit 206 can communicate with the imaging apparatus attached to the lens apparatus 200 via the lens mount 202. In the present specification, the lens communication control unit 206 corresponds to a first communication unit.

The storage unit 207 stores lens-specific information and, in this configuration, stores compound eye support information. The compound eye support information is information related to compound eye imaging, including information as to whether the lens apparatus L0 supports compound eye imaging. Here, compound eye imaging refers to an imaging method that uses a plurality of lens apparatuses, and, for example, a method for using two wide-viewing-angle lens apparatuses arranged back to back to capture an image in a wide angle of 360° as in an imaging system described below.

The storage unit 207 also stores information about an image circle of the lens apparatus L0.

The lens CPU 203 transmits information detected by the zoom position detection unit 205 and information stored in the storage unit 207 to the imaging apparatus via the lens communication control unit 206.

The focus driving unit 204 drives the focus lens based on the information received from the lens CPU 203 to perform focusing.

Next, an electrical configuration of the imaging apparatus to which the lens apparatus L0 according to the present embodiment is applied will be described.

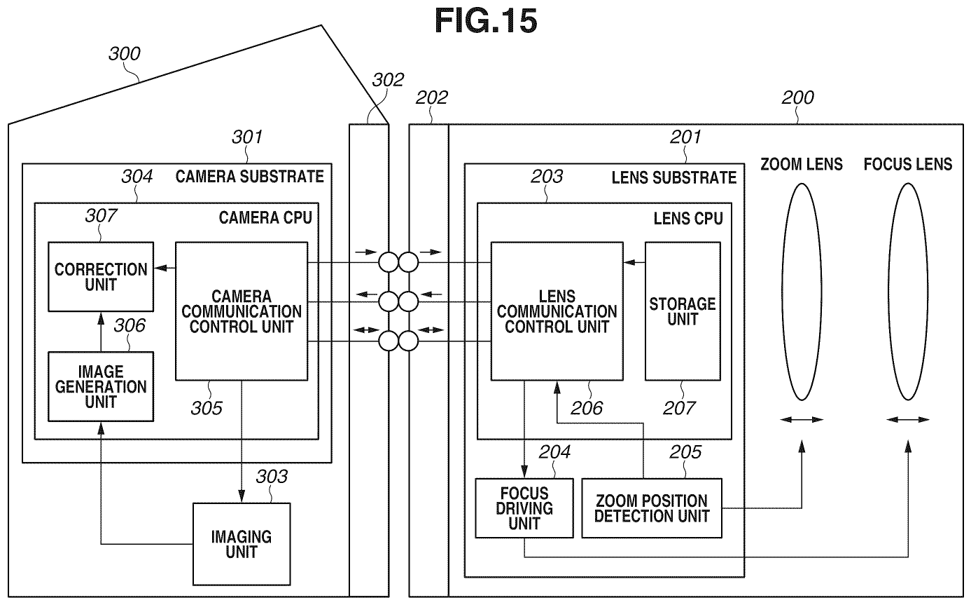

FIG. 15 is a schematic diagram related to an electrical configuration of an imaging apparatus 300 to which the lens apparatus L0 according to the present embodiment is applied.

The imaging apparatus 300 includes a camera substrate 301, a camera mount 302, and an imaging unit 303. The camera mount 302 can attach the above-described lens apparatus L0 thereto, and the lens apparatus L0 is attached to the imaging apparatus 300 via the lens mount 202 as illustrated in the drawing.

The camera substrate 301 includes the imaging unit 303 and a camera CPU 304.

The imaging unit 303 captures an image by photoelectrically converting an optical image formed by the lens apparatus L0.

The camera CPU 304 includes a camera communication control unit 305, an image generation unit 306, and a correction unit 307.

The camera communication control unit 305 controls communication between the lens apparatus L0 and the imaging apparatus 300 via the camera mount 302. In the present specification, the camera communication control unit 305 corresponds to a second communication unit.

The image generation unit 306 generates an image based on an image signal photoelectrically converted by the imaging unit 303.

The correction unit 307 corrects the image generated by the image generation unit 306. Correction of an image described here means setting imaging conditions such as brightness, imaging sensitivity, white balance, and the like. A specific correction method is described below.

Next, a characteristic configuration of the lens apparatus L0 according to each embodiment will be described.

The lens apparatus L0 according to each embodiment is a negative lead type lens apparatus in which the first lens unit L1 has the negative refractive power. In one embodiment, a lens G1 that is closest to the object among the lenses included in the first lens unit L1 is fixed with respect to the image plane IP in zooming. Accordingly, a total optical length of the lens apparatus L0 does not change in zooming, and robustness of the lens apparatus L0 can be improved.

Assume that a half angle of view corresponding to a maximum image height in focusing at infinity at the wide-angle end of the lens apparatus L0 according to each embodiment is ωw (°), a wide angle of view required for a fisheye lens apparatus or a super-wide angle lens apparatus can be acquired by satisfying a conditional expression ωw>90. To acquire a sufficiently wide angle of view as a fisheye lens apparatus or a super-wide angle lens apparatus, in one embodiment, a conditional expression ωw>92 is satisfied. In another embodiment, a conditional expression ωw>94 is satisfied.

Next, conditions that the lens apparatus L0 according to each embodiment satisfies will be described.

In one embodiment, the lens apparatus L0 according to each embodiment satisfies at least one or more of following conditional expressions (1) to (12). In each conditional expression, various values are expressed as follows.

Assume that a focal length of the first lens unit L1 is fL1, and a focal length of a second lens unit L2 is fL2.

Assume that a focal length of the lens apparatus L0 at the wide-angle end is fw.

Assume that a focal length of the lens G1 arranged closest to the object in the first lens unit L1 is fG1, and a focal length of a lens G2 arranged adjacent to the lens G1 on the image side is defined as fG2.

Assume that a focal length of the focusing unit LF is fLF.

Assume that a focal length of the rear unit LR at the wide-angle end of the lens apparatus L0 is fLRw.

Assume that a back focal length of the wide-angle end of the lens apparatus L0 is Skw.

Assume that a distance on the optical axis from the aperture stop SP of the lens apparatus L0 at the wide-angle end to a lens surface closest to the image is DSPw.

Assume that a refractive index of a material of the lens G1 closest to the object in the first lens unit L1 with respect to the d-line is ndG1.

In lens surfaces of the lens G1 closest to the object in the first lens unit L1, assume that a curvature radius of an object side lens surface is R1, and that a curvature radius of an image side lens surface is R2.

Assume that the maximum image height that can be captured at the telephoto end of the lens apparatus L0 is Yta, and that the maximum image height that can be captured at the wide-angle end thereof is Ywa.

$$- 3. < fL 1 / fw < - 1.7 \qquad ( 1 )$$

$$- 5. < \vert fL 2 \vert / fL 1 < - 1.1 \qquad ( 2 )$$

$$1.4 < fG 1 , fL 1 < 3. \qquad ( 3 )$$

$$0.4 < fG 1 / fG 2 < 1.6 \qquad ( 4 )$$

$$3.5 < fLF / fw < 15. \qquad ( 5 )$$

$$\begin{matrix}- 4.1 < fLF / fL 1 - 1.8 & ( 6 )\end{matrix}$$

$$- 1.3 < fL 1 / fLRw < - 0.55 \qquad ( 7 )$$

$$\begin{matrix}2. < Skw / fw < 6. & ( 8 )\end{matrix}$$

$$0.4 < DSPw / Skw < 1. \qquad ( 9 )$$

$$1.65 < ndG 1 < 2.2 \qquad ( 10 )$$

$$1.3 < ( R 1 + R 2 ) / ( R 1 - R 2 ) < 3. \qquad ( 11 )$$

$$1.5 < Yta / Ywa < 3. \qquad ( 12 )$$

A technical meaning of the above-described conditional expressions (1) to (12) will now be described.

The conditional expression (1) defines a ratio of the focal length fL1 of the first lens unit L1 to the focal length fw of the lens apparatus L0 at the wide-angle end. By satisfying the conditional expression (1), the focal length fL1 of the first lens unit L1 can be appropriately arranged, and the distortion aberration, magnification chromatic aberration, and the curvature of field can be satisfactorily corrected. When the focal length fL1 of the first lens unit L1 is too long and falls below a lower limit of the conditional expression (1), the first lens unit L1 becomes large, making it difficult to reduce a size of the lens apparatus L0. When the focal length fL1 of the first lens unit L1 is too short and exceeds an upper limit of the conditional expression (1), an image height change due to coma aberration becomes large, making it difficult to correct the curvature of field or astigmatism.

The conditional expression (2) defines a ratio of the focal length fL2 of the second lens unit L2 to the focal length fL1 of the first lens unit L1. By satisfying the conditional expression (2), the focal length fL1 of the first lens unit L1 and the focal length fL2 of the second lens unit L2 can be appropriately arranged, so that the distortion aberration, magnification chromatic aberration, and the curvature of field can be satisfactorily corrected. When the focal length fL1 of the first lens unit L1 is too short and falls below the lower limit of the conditional expression (2), the image height change due to off-axial coma aberration becomes large, making it difficult to correct the curvature of field and astigmatism. When the focal length fL1 of the first lens unit L1 is too long and exceeds the upper limit of the conditional expression (2), the first lens unit L1 becomes large, making it difficult to reduce the size of the lens apparatus L0.

The conditional expression (3) defines a ratio of the focal length fG1 of the lens G1 closest to the object in the first lens unit L1 to the focal length fL1 of the first lens unit L1. By satisfying the conditional expression (3), the focal length fG1 of the lens G1 can be appropriately arranged, and the distortion aberration, magnification chromatic aberration, and curvature of field can thereby be satisfactorily corrected. When the focal length fG1 of the lens G1 is too short and falls below the lower limit of the conditional expression (3), it becomes difficult to correct the curvature of field and distortion. When the focal length fG1 of the lens G1 is too long and exceeds the upper limit of the conditional expression (3), the first lens unit L1 becomes large, making it difficult to reduce the size of the lens apparatus L0.

The conditional expression (4) defines a ratio of the focal length fG1 of the lens G1 closest to the object in the first lens unit L1 to the focal length fG2 of the lens G2 arranged adjacent to the lens G1 on the image side. Two negative lenses are arranged in order from the object side to achieve a wide angle of view. When the focal length fG1 of the lens G1 is too short and falls below the lower limit of the conditional expression (4), it becomes difficult to correct the curvature of field and distortion. When the focal length fG1 of the lens G1 is too long and exceeds the upper limit of the conditional expression (4), the lens G1 and the first lens unit L1 become large, making it difficult to reduce the size of the lens apparatus L0.

The conditional expression (5) defines a ratio of the focal length fLF of the focusing unit LF to the focal length fw of the lens apparatus L0 at the wide-angle end. When the focal length fLF of the focusing unit LF is too short and falls below the lower limit of the conditional expression (5), it becomes difficult to suppress variations in various aberrations, including the spherical aberration associated with focusing. When the focal length fLF of the focusing unit LF is too long and exceeds the upper limit of the conditional expression (5), a movement amount associated with focusing becomes large, making it difficult to reduce the size of the lens apparatus L0.

The conditional expression (6) defines a ratio of the focal length fLF of the focusing unit LF to the focal length fL1 of the first lens unit L1. When the focal length fLF of the focusing unit LF is too long and falls below the lower limit of the conditional expression (6), the movement amount associated with focusing becomes large, making it difficult to reduce the size of the lens apparatus L0. When the focal length fLF of the focusing unit LF is too short and exceeds the upper limit of the conditional expression (6), it becomes difficult to suppress variations in various aberrations, including the spherical aberration associated with focusing.

The conditional expression (7) defines a ratio of the focal length fL1 of the first lens unit L1 to the focal length fLRw of the rear unit LR at the wide-angle end. When the focal length fL1 of the first lens unit L1 is too long and falls below the lower limit of the conditional expression (7), a converging action of the rear unit LR becomes large, magnification of chromatic aberration and axial chromatic aberration are strongly generated, resulting in deterioration of optical performance. When the focal length fL1 of the first lens unit L1 is too short and exceeds the upper limit of the conditional expression (7), it becomes difficult to correct the spherical aberration and coma aberration in the rear unit LR.

The conditional expression (8) defines a ratio of the back focal length Skw at the wide-angle end to the focal length fw of the lens apparatus L0 at the wide-angle end. When the back focal length Skw is too short and falls below the lower limit of the conditional expression (8), it becomes difficult to arrange an optical element such as a low-pass filter or the like near an imaging element that photoelectrically converts an optical image formed by the lens apparatus L0.

When the back focal length Skw is too long exceeding the upper limit of the conditional expression (8), the total optical length of the lens apparatus L0 at the wide-angle end becomes long, making it difficult to reduce the size of the lens apparatus L0.

The conditional expression (9) defines a ratio of the distance DSPw on the optical axis from the aperture stop SP at the wide-angle end to the lens surface closest to the image to the back focal length Skw at the wide-angle end. When the distance DSPw on the optical axis from the aperture stop SP to the lens surface closest to the image is too short and falls below the lower limit of the conditional expression (9), it becomes difficult to arrange the focusing unit LF. When the back focal length Skw is too short and exceeds the upper limit of the conditional expression (9), the total optical length of the lens apparatus L0 at the wide-angle end becomes long, making it difficult to reduce the size of the lens apparatus L0.

The conditional expression (10) defines the refractive index ndG1 of the material of the lens G1 closest to the object in the first lens unit L1 with respect to the d-line. By satisfying the conditional expression (10), the refractive index ndG1 of the material of the lens G1 can be set in an appropriate range, and the magnification chromatic aberration can thereby be satisfactorily corrected.

When the refractive index ndG1 of the lens G1 closest to the object is too small and falls below the lower limit of the conditional expression (10), in one embodiment, a refractive power of the negative lens is weaken to correct the curvature of field, which results in an increase of the back focal length and makes it difficult to reduce the size of the lens apparatus L0. When the upper limit of the conditional expression (10) is exceeded, the refractive index ndG1 of the lens G1 closest to the object becomes too large, and a highly dispersion material with a small Abbe number is selected, making it difficult to satisfactorily correct the distortion aberration and magnification chromatic aberration.

The conditional expression (11) defines a shape of the lens G1 closest to the object in the first lens unit L1. The curvature radius of the object side lens surface of the lens G1 closest to the object is defined as R1, and the curvature radius of the image side lens surface of the lens G1 closest to the object is defined as R2. When the lower limit of the conditional expression (11) falls below the lower limit of the conditional expression (11), the refractive power of the lens G1 closest to the object becomes too strong, making it difficult to acquire high optical performance. When the upper limit of the conditional expression (11) is exceeded, the refractive power of the lens G1 closest to the object becomes too weak, making it difficult to achieve a wide angle of view.

The conditional expression (12) defines a ratio of the maximum image height Yta that can be captured at the telephoto end to the maximum image height Ywa that can be captured at the wide-angle end. The maximum image height refers to a distance between the optical axis and an image point at which a peripheral light amount is 15% among image points that can be captured. When the maximum image height at the telephoto end is too small and falls below the lower limit of the conditional expression (12), it becomes difficult to make the lens apparatus L0 a wide-angle lens apparatus that includes from circular fisheye to diagonal fisheye.

When the maximum image height at the telephoto end is too large and exceeds the upper limit of the conditional expression (12), a movement amount of each lens unit in zooming or the refractive power of each lens unit becomes large, making it difficult to suppress various aberrations in zooming.

In one embodiment, numerical ranges of the conditional expressions (1) to (12) are set to the numerical ranges of following conditional expression (1a) to (12a).

$$- 2.6 < fL 1 / fw < - 1.9 \qquad ( 1 a )$$

$$- 3.6 < \vert fL 2 \vert / fL 1 < - 1.6 \qquad ( 2 a )$$

$$1.6 < fG 1 / fL 1 < 2.7 \qquad ( 3 a )$$

$$0.47 < fG 1 / fG 2 < 1.3 \qquad ( 4 a )$$

$$4.4 < fLF / fw < 10. \qquad ( 5 a )$$

$$\begin{matrix}- 3.9 < fLF / fL 1 < - 2.1 & ( 6 a )\end{matrix}$$

$$- 1.2 < fL 1 / fLRw < - 0.6 \qquad ( 7 a )$$

$$\begin{matrix}4. < Skw / fw < 5.3 & ( 8 a )\end{matrix}$$

$$0.5 < DSPw / Skw < 0.81 \qquad ( 9 a )$$

$$1.66 < ndG 1 < 1.96 \qquad ( 10 a )$$

$$1.5 < ( R 1 + R 2 ) / ( R 1 - R 2 ) < 2.7 \qquad ( 11 a )$$

$$1.8 < Yta / Ywa < 2.3 \qquad ( 12 a )$$

In one embodiment, the numerical ranges of the conditional expressions (1) to (12) is set to the numerical ranges of following conditional expression (1b) to (12b).

$$- 2.5 < fL 1 / fw < - 2. \qquad ( 1 b )$$

$$- 3.4 < \vert fL 2 \vert / fL 1 < - 1.7 \qquad ( 2 b )$$

$$1.7 < fG 1 / fL 1 < 2.6 \qquad ( 3 b )$$

$$0.48 < fG 1 / fG 2 < 1.2 \qquad ( 4 b )$$

$$4.6 < fLF / fw < 8. \qquad ( 5 b )$$

$$- 3.7 < fLF / fL 1 < - 2.2 \qquad ( 6 b )$$

$$- 1.1 < fL 1 / fLRw < - 0.63 \qquad ( 7 b )$$

$$4.3 < Skw / fw < 4.9 \qquad ( 8 b )$$

$$0.53 < DSPw / Skw < 0.79 \qquad ( 9 b )$$

$$1.71 < ndG 1 < 1.91 \qquad ( 10 b )$$

$$1.7 < ( R 1 + R 2 ) / ( R 1 - R 2 ) < 2.5 \qquad ( 11 b )$$

$$1.9 < Yta / Ywa < 2.1 \qquad ( 12 b )$$

Next, a configuration that is satisfied in the lens apparatus L0 according to each embodiment will be described.

In the lens apparatus L0 according to each embodiment, the first lens unit L1 includes two or more negative lenses in order from the object side. In one embodiment, the lens G1 closest to the object has a meniscus shape convex toward the object side, and a surface vertex on the object side of the lens G1 closest to the object is located closer to the object side than a first lens barrel 111. It thereby becomes easier to make the lens apparatus L0 have a wider angle.

In the lens apparatus L0 according to each embodiment, the lens G1 that is arranged closest to the object have a meniscus shape with its object side lens surface and image side lens surface convex toward the object side, as this can facilitate manufacture of the lens apparatus L0 while satisfying necessary optical performance.

In the lens apparatus L0 according to each embodiment, the first lens unit L1 is configured with two negative lenses. In the lens apparatus L0 according to each embodiment, all lenses included in the first lens unit L1 are spherical lenses, as this can further facilitate the manufacture of the lens apparatus L0.

In the lens apparatus L0 according to each embodiment, the focusing unit LF is configured with two or less lenses and arranged closer to the image than the aperture stop SP, since this can make it easier to reduce the size of the focusing unit LF and increase a speed of focusing. The lens apparatus L0 according to each embodiment also adopts a rear focus type in which the focusing unit LF is included in the rear unit LR. Accordingly, the overall lens length does not change in focusing, making it possible to suppress breathing caused by focusing.

In the lens apparatus L0 according to each embodiment, the rear unit LR is configured with three or more lens units since this makes it possible to achieve a sufficient zoom ratio.

The lens apparatus L0 according to each embodiment can be provided with distortion correction data for correcting distortion aberration. The lens apparatus L0 can thereby correct distortion aberration occurring in a lens optical system.

Next, first to sixth numerical examples respectively corresponding to the first to sixth embodiments will be described below. In surface data of each numerical example, r is a curvature radius of each optical surface, and d (mm) is a distance on the optical axis between an m-th surface and an (m+1)-th surface. Here, m is the surface number counted from a light incident side. Nd is a refractive index of a material of each optical member with respect to the d-line, and νd is the Abbe number of the material of the optical member. The Abbe number νd of a certain material can be expressed by a following formula:

$$vd = ( Nd - 1 ) / ( NF - NC ) ,$$

where Nd, NF, and NC are the refractive indices at the d-line (587.6 nm), F-line (486.1 nm), and C-line (656.3 nm) of the Fraunhofer lines.

In each numerical example, the distance d, focal length (mm), F-number, and half angle of view (°) are all values in a case where the lens apparatus L0 according to each embodiment is focused on an object at infinity. The back focal length is a distance from the lens surface of the lens apparatus L0 closest to the image to a paraxial image plane ∞ n the optical axis, expressed as an air equivalent length. The overall lens length is a length obtained by adding the back focal length to the distance from the lens surface closest to the object to the lens surface closest to the image on the optical axis of the lens apparatus L0. The lens unit according to each numerical example is not limited to a unit including a plurality of lenses, but also a unit including a single lens.

In a case where an optical surface is an aspherical surface, a symbol * is added to the right side of a surface number. The aspherical shape is expressed by a following formula, where X is a displacement amount from a surface vertex in an optical axis direction, h is a height from the optical axis in a direction perpendicular to the optical axis, R is a paraxial curvature radius, K is a conic constant, and A4, A6, A8, A10, and A12 are aspherical coefficients of each order:

$$X = ( {h}^{2} / R ) {/ [ 1 - ( 1 + K ) {( h / R )}^{2} ]}^{1 / 2} ] + A 4 * {h}^{4} + A 6 * {h}^{6} + A 8 * {h}^{8} + A 10 * {h}^{10} + A 12 * {h}^{12}$$

In each aspherical coefficient, “e±XX” represents “*10±^{XX}”.

### First Numerical Example

Unit mm
Surface data
Surface number r d nd νd
1 48.932 2.00 1.85150 40.8
2 20.284 16.25
3 557.363 1.10 1.80400 46.5
4 28.772 (variable)
5 34.855 0.90 1.85896 22.7
6 17.068 0.10 1.53344 52.7
7* 17.589 4.70
8 50.857 6.99 1.83400 37.2
9 −20.635 1.05 1.49700 81.7
10 22.129 4.34
11 −16.265 0.80 1.49700 81.7
1221.161 3.64 1.66565 35.6
13 −55.693 (variable)
14 21.234 3.68 1.63980 34.5
15 −27.788 0.70 1.90043 37.4
16 12.518 4.24 1.59270 35.3
17 −87.908 0.91
18 (aperture) ∞ 2.09
19 42.390 4.09 1.49700 81.7
20 −19.741 (variable)
21 −19.756 0.90 2.00100 29.1
22 −46.915 0.10 1.53344 52.7
23* −32.818 0.25
2449.974 5.10 1.49700 81.7
25 −15.524 (variable)
26 −39.407 0.70 1.81600 46.6
27 24.127 5.47 1.49700 81.7
28 −23.248 (variable)
Image plane ∞
Aspherical surface data
7-th surface
K=0.00000e+00 A 4=4.48181e−07 A 6=3.99220e−08 A 8=−9.08985e−11 A10=1.59194e−12 A12=−4.38981e−15
23rd surface
K=0.00000e+00 A 4=6.12566e−05 A 6=1.17826e−07 A 8=2.22470e−09 A10=−3.70114e−11 A12=2.37590e−13
Various data
Zoom ratio 2.00
Wide-angle Intermediate Telephoto
Focal length 6.81 9.58 13.60
F-number 2.85 3.23 3.60
Half angle of view 94.94 87.43 89.96
Image height 11.15 14.80 21.64
Overall lens length 127.71 127.71 127.71
BF 30.73 40.08 49.42
d 4 6.34 6.31 2.10
d13 15.72 6.40 1.27
d20 2.33 3.71 3.67
d25 2.47 1.10 1.14
d28 30.73 40.08 49.42
Lens apparatus unit data
Unit Starting surface Focal length
L1 1 −16.55
L2 5 −42.17
L3 14 26.64
L4 21 47.74
L5 26 −101.75

### Second Numerical Example

Unit mm
Surface data
Surface number r d nd νd
1 55.485 2.30 1.85150 40.8
2 19.371 17.05
3 −1103.546 1.30 1.90525 35.0
4 34.645 (variable)
5 37.524 0.90 1.89286 20.4
6 18.491 0.10 1.58946 30.6
7* 18.199 2.37
8 31.026 8.14 1.78880 28.4
9 −20.624 1.10 1.49700 81.7
10 16.423 5.40
11 −14.389 0.80 1.49700 81.7
1218.091 3.89 1.6134044.3
13 −39.413 (variable)
14 18.952 4.42 1.53172 48.8
15 −17.614 0.09
16 −17.868 0.70 1.88300 40.8
17 15.902 4.19 1.59270 35.3
18 −41.659 1.44
19 (aperture) ∞ 1.27
20 34.703 4.01 1.49700 81.7
21 −25.217 (variable)
22 −26.388 0.80 1.88300 40.8
23 −78.439 0.10 1.53344 52.7
24* −49.028 0.15
25 31.715 4.97 1.49700 81.7
26 −18.785 (variable)
27 −53.258 0.75 1.88300 40.8
28 19.564 4.78 1.49700 81.7
29 −25.590 (variable)
Image plane ∞
Aspherical surface data
7-th surface
K=0.00000e+00 A 4=−9.88827e−06 A 6=6.80002e−09 A 8=−9.44113e−12 A10=1.04890e−12 A12=−2.43934e−15
24-th surface
K=0.00000e+00 A 4=5.68392e−05 A 6=1.09227e−07 A 8=3.24013e−10 A10=
1.13582e−12 A12=−2.42531e−14
Various data
Zoom ratio 1.97
Wide-angle Intermediate Telephoto
Focal length 6.80 9.52 13.41
F-number 2.86 3.22 3.61
Half angle of view 95.03 88.50 91.04
Image height 11.15 14.80 21.60
Overall lens length 126.11 126.11 126.11
BF 30.90 39.23 47.55
d 4 4.47 5.13 1.29
d13 14.12 5.13 0.65
d21 4.03 3.69 2.74
d26 1.58 1.92 2.87
d29 30.90 39.23 47.55
Lens apparatus unit data
Unit Starting surface Focal length
L1 1 −14.82
L2 5 −38.96
L3 14 27.05
L4 22 39.68
L5 27 −68.35

### Third Numerical Example

Unit mm
Surface data
Surface number r d nd νd
1 52.863 2.00 1.85150 40.8
2 19.811 16.64
3 268.068 1.30 2.00100 29.1
4 31.150 (variable)
5 159.698 4.99 1.95375 32.3
6 −30.207 1.20 1.49700 81.7
7 16.611 5.20
8 −17.533 0.80 1.49700 81.7
9 18.643 0.28
10 19.966 6.58 1.78880 28.4
11 −12.466 0.80 2.00100 29.1
12 −61.500 (variable)
13* 55.457 0.10 1.58946 30.6
14 97.068 3.52 1.56732 42.8
15 −14.576 0.05
16 −14.461 0.80 2.00100 29.1
17 22.989 3.89 1.59270 35.3
18 −25.500 0.15
19 52.181 4.70 1.63980 34.5
20 −16.612 0.30
21 (aperture) ∞ (variable)
22 −20.107 0.80 1.95375 32.3
23 −48.225 0.10 1.58946 30.6
24* −37.531 0.15
25 48.217 4.74 1.49700 81.7
26 −16.669 (variable)
27 −101.305 0.80 1.88300 40.8
28 18.672 3.74 1.49700 81.7
29 −30.910 (variable)
Image plane ∞
Aspherical surface data
13-th surface
K=0.00000e+00 A 4=−5.40095e−05 A 6=−1.58648e−07 A 8=−6.84435e−09 A10=1.41530e−10 A12=−1.69897e−12
24-th surface
K=0.00000e+00 A 4=3.89315e−05 A 6=1.19235e−07 A 8=−4.99023e−10 A10=
1.75021e−11 A12=−1.12723e−13
Various data
Zoom ratio 1.97
Wide-angle Intermediate Telephoto
Focal length 6.82 9.56 13.42
F-number 2.83 3.21 3.60
Half angle of view 94.95 88.37 91.14
Image height 11.15 14.80 21.60
Overall lens length 123.73 123.73 123.73
BF 32.13 40.19 48.25
d 4 7.71 7.34 3.55
d12 13.02 5.32 1.05
d21 5.99 6.19 5.14
d26 1.25 1.05 2.10
d29 32.13 40.19 48.25
Lens apparatus unit data
Unit Starting surface Focal length
L1 1 −14.97
L2 5 −42.81
L3 13 23.42
L4 22 53.48
L5 27 −82.35

### Fourth Numerical Example

Unit mm
Surface data
Surface number r d nd νd
1 60.163 2.60 1.83481 42.7
2 21.063 12.33
3 109.832 1.50 1.59522 67.7
4 17.672 (variable)
5 150.019 4.20 1.72047 34.7
6 −51.359 1.58
7 −37.627 0.90 1.89190 37.1
8 91.089 2.62
9 −17.827 0.85 1.49700 81.7
10 19.500 0.71
11 24.491 4.63 1.75520 27.5
12 −127.292 (variable)
13* 32.487 0.05 1.58946 30.6
14 24.928 6.44 1.53172 48.8
15 −10.792 0.85 2.00100 29.1
16 −49.566 0.15
17 260.837 3.61 1.59270 35.3
18 −19.964 0.06
19 −83.132 0.90 1.77250 49.6
20 12.974 5.93 1.59270 35.3
21 −21.635 0.87
22 (aperture) ∞ (variable)
23 20.807 4.87 1.49700 81.7
24 −19.178 0.15
25 −22.797 0.80 2.00100 29.1
26 −66.112 (variable)
27 −2019.764 0.80 1.88300 40.8
28 21.543 2.23
29 31.926 3.93 1.49700 81.7
30 −24.775 (variable)
Image plane ∞
Aspherical surface data
13-th surface
K=0.00000e+00 A 4=7.64291e−06 A 6=4.60507e−07 A 8=−1.46830e−08 A10=
3.93238e−10 A12=−3.23460e−12
Various data
Zoom ratio 2.06
Wide-angle Intermediate Telephoto
Focal length 7.22 10.80 14.86
F-number 2.88 3.61 4.12
Half angle of view 99.23 96.79 92.92
Image height 10.75 16.00 21.60
Overall lens length 128.99 128.99 128.99
BF 32.52 42.88 49.78
d 4 9.19 8.61 5.93
d12 14.96 5.18 0.95
d22 7.59 6.65 3.60
d26 1.17 2.11 5.15
d30 32.52 42.88 49.78
Lens apparatus unit data
Unit Starting surface Focal length
L1 1 −16.14
L2 5 −36.44
L3 13 35.25
L4 23 46.70
L5 27 −822.66

### Fifth Numerical Example

Unit mm
Surface data
Surface number r d nd νd
1 58.998 2.50 1.76385 48.5
2 15.716 16.74
3 −118.695 1.40 1.59282 68.6
4 37.945 (variable)
52.243 3.96 1.66565 35.6
6 −30.668 0.59
7 −22.962 1.00 1.90043 37.4
8 23.854 (variable)
923.518 3.91 1.66565 35.6
20.591 1.00 1.49700 81.7
11 22.024 (variable)
1218.264 1.00 1.88300 40.8
13 11.917 4.60 1.6843026.8
14 −39.891 0.15
32.692 1.00 2.05090 26.9
16 17.207 5.02 1.59410 60.5
17 −18.631 0.50
18 (aperture) ∞ (variable)
19 20.545 2.96 1.53775 74.7
202.410 (variable)
21 −60.820 1.28 1.77250 49.6
22* 52.786 0.52
23 80.866 3.72 1.49700 81.7
24 −23.726 0.15
31.425 1.31 1.88300 40.8
26 52.500 3.91 1.49700 81.7
27 −17.095 (variable)
Image plane ∞
Aspherical surface data
22nd surface
K=0.00000e+00 A 4=2.64230e−05 A 6=−4.03358e−09 A 8=7.40566e−10 A10=−2.79295e−11 A12=2.33887e−13
Various data
Zoom ratio 2.03
Wide-angle Intermediate Telephoto
Focal length 7.24 10.93 14.69
F-number 4.10 4.10 4.10
Half angle of view 98.14 94.28 93.38
Image height 10.75 16.00 21.60
Overall lens length 127.38 127.38 127.38
BF 32.32 43.68 51.25
d 4 13.34 9.39 4.19
d 8 5.91 6.34 6.60
d11 11.80 3.96 1.33
d18 3.21 3.73 3.00
d20 3.58 3.06 3.79
d27 32.32 43.68 51.25
Lens apparatus unit data
Unit Starting surface Focal length
L1 1 −14.79
L2 5 −25.40
L3 9 64.83
L4 12 41.50
L5 19 34.85
L6 21 −442.01

### Sixth Numerical Example

Unit mm
Surface data
Surface number r d nd νd
1 58.154 2.50 1.76385 48.5
2 15.775 16.08
3 −425.603 1.40 1.59282 68.6
4 37.744 (variable)
5 248.610 5.62 1.77047 29.7
6 −19.550 1.00 1.95906 17.5
7 −38.557 (variable)
8 −22.637 1.00 1.91354 36.8
9 28.532 3.85
10 28.132 5.18 1.77047 29.7
11 −21.134 1.00 1.43875 94.7
12 22.654 (variable)
13 24.356 6.32 1.68430 26.8
14 −13.488 1.00 2.00100 29.1
15 28.4814.91 1.51823 58.9
16 −15.181 0.40
17 (aperture) ∞ (variable)
18 22.580 3.05 1.49700 81.7
19 −104.450 (variable)
20 −34.188 1.28 1.76450 49.1
21* 87.503 2.04
22 32.469 4.26 1.49700 81.7
23 −18.234 0.15
24 −176.617 1.31 1.88300 40.8
25 19.236 3.68 1.49700 81.7
26 −61.995 (variable)
Image plane ∞
Aspherical surface data
21st surface
K=0.00000e+00 A 4=3.50880e−05 A 6=1.70964e−08 A 8=3.91104e−09 A10=−9.58126e−11 A12=7.92141e−13
Various data
Zoom ratio 2.06
Wide-angle Intermediate Telephoto
Focal length 7.25 11.01 14.97
F-number 4.10 4.10 4.10
Half angle of view 97.86 93.05 90.55
Image height 10.75 16.00 21.60
Overall lens length 131.41 131.41 131.41
BF 32.32 43.52 50.99
d 4 11.62 9.61 3.44
d 7 1.54 1.48 2.68
d12 13.54 4.41 1.90
d17 4.43 4.43 3.35
d19 1.921.92 3.00
d26 32.32 43.52 50.99
Lens apparatus unit data
Unit Starting surface Focal length
L1 1 −16.36
L2 5 54.77
L3 8 −23.38
L4 13 42.94
L5 18 37.66
L6 20 −345.10
The various values in each numerical example are summarized in Table 1 below.

TABLE 1

| | First | Second | Third | Fourth | Fifth | Sixth |
|---|---|---|---|---|---|---|
| | Embodiment | Embodiment | Embodiment | Embodiment | Embodiment | Embodiment |
| fw | 6.81 | 6.80 | 6.82 | 7.22 | 7.24 | 7.25 |
| fL1 | −16.55 | −14.82 | −14.97 | −16.14 | −14.79 | −16.36 |
| fL2 | −42.17 | −38.96 | −42.81 | −36.44 | −25.40 | 54.77 |
| fG1 | −42.04 | −36.01 | −38.28 | −40.03 | −28.76 | −29.08 |
| fG2 | −37.77 | −37.09 | −35.31 | −35.60 | −48.34 | −58.42 |
| fLF | 47.74 | 39.68 | 53.48 | 46.70 | 34.85 | 37.66 |
| fLR | 18.64 | 19.44 | 19.75 | 20.20 | 22.67 | 21.53 |
| Skw | 30.73 | 30.90 | 32.13 | 32.52 | 32.32 | 32.32 |
| DSPw | 23.51 | 22.44 | 17.57 | 21.54 | 20.63 | 22.12 |
| ndG1 | 1.85 | 1.85 | 1.85 | 1.83 | 1.76 | 1.76 |
| R1 | 48.93 | 55.48 | 52.86 | 60.16 | 59.00 | 58.15 |
| R2 | 20.28 | 19.37 | 19.81 | 21.06 | 15.72 | 15.78 |
| Yta | 21.64 | 21.60 | 21.60 | 21.60 | 21.60 | 21.60 |
| Ywa | 11.15 | 11.15 | 11.15 | 10.75 | 10.75 | 10.75 |
| (1) | −2.43 | −2.18 | −2.20 | −2.23 | −2.04 | −2.26 |
| (2) | −2.55 | −2.63 | −2.86 | −2.26 | −1.72 | −3.35 |
| (3) | 2.54 | 2.43 | 2.56 | 2.48 | 1.94 | 1.78 |
| (4) | 1.11 | 0.97 | 1.08 | 1.12 | 0.60 | 0.50 |
| (5) | 7.00 | 5.83 | 7.84 | 6.47 | 4.82 | 5.19 |
| (6) | −2.88 | −2.68 | −3.57 | −2.89 | −2.36 | −2.30 |
| (7) | −0.89 | −0.76 | −0.76 | −0.80 | −0.65 | −0.76 |
| (8) | 4.51 | 4.54 | 4.71 | 4.50 | 4.47 | 4.46 |
| (9) | 0.77 | 0.73 | 0.55 | 0.66 | 0.64 | 0.68 |
| (10) | 1.85 | 1.85 | 1.85 | 1.83 | 1.76 | 1.76 |
| (11) | 2.42 | 2.07 | 2.20 | 2.08 | 1.73 | 1.74 |
| (12) | 1.94 | 1.94 | 1.94 | 2.01 | 2.01 | 2.01 |

### [Imaging Apparatus]

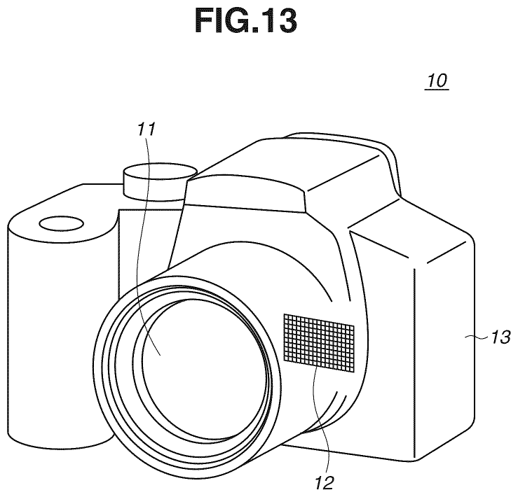

Next, an imaging apparatus to which the lens apparatus L0 according to the present embodiment is applied will be described. FIG. 13 is a schematic diagram of an imaging apparatus 10 according to the present embodiment. The imaging apparatus 10 includes a camera main body 13, a lens apparatus 11, which is similar to any of the first to sixth embodiments, and a light receiving element 12 for photoelectrically converting an optical image formed by the lens apparatus 11.

The imaging apparatus 10 according to the present embodiment includes the lens apparatus 11 that is small and has excellent optical characteristics and thus can acquire a high-quality image.

As the light receiving element 12, an imaging element, such as a CCD or a CMOS sensor, can be used. At this time, various aberrations such as distortion aberration and chromatic aberration of the image acquired by the light receiving element 12 can be electrically corrected to improve a quality of an output image.

The above-described lens apparatus L0 according to each embodiment can be applied not only to a digital still camera illustrated in FIG. 13, but also to various optical devices such as a silver-halide film camera, a video camera, a telescope, and the like.

### [Imaging System]

Next, an imaging system to which the lens apparatus and the imaging apparatus according to the present embodiment are applied will be described.

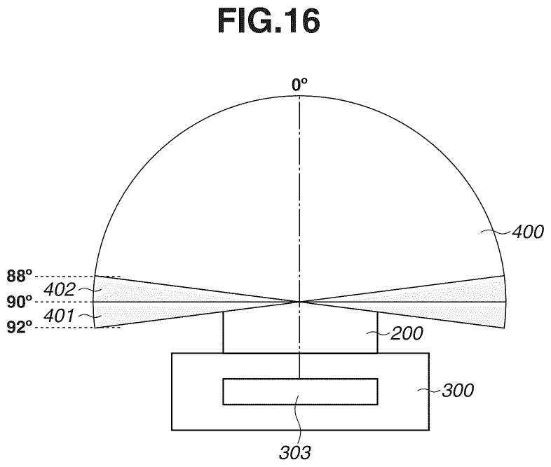

FIG. 16 is a top view of the imaging apparatus 300 to which the lens apparatus 200 according to the present embodiment is applied. Here, the imaging apparatus 300 has a configuration similar to that of the above-described imaging apparatus 10. The lens apparatus 200 is at the wide-angle end, and a half angle of view ωw corresponding to the maximum image height is 92°. Parameters of the lens apparatus 200 and the imaging apparatus 300 in FIG. 16 are merely examples and are not limited thereto.

In FIG. 16, an image-pickup area 400 indicates a range in which the imaging unit 303 of the imaging apparatus 300 can capture an image in an angle of view of the lens apparatus 200. A range at an end of the angle of view of the image-pickup area 400 in which the angle of view corresponding to the maximum image height at the wide-angle end is wider than 90°, that is, a range in which the angle of view is from 90° to 92° in the present embodiment is defined as a first range 401. A range inside the first range 401, which is the end of the angle of view of the image-pickup area 400, that is, a range where the angle of view is from 88° to 90° in the present embodiment is defined as a second range 402. It is not illustrated, but the first range 401 and the second range 402 have a range of 360° in a direction of rotation around the optical axis.

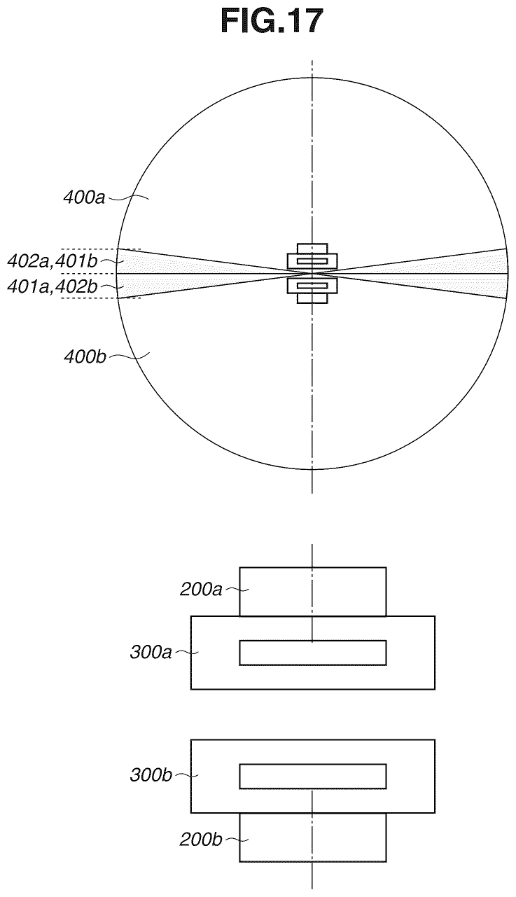

FIG. 17 is a top view of the imaging system that performs compound eye imaging using two imaging apparatuses 300 according to the present embodiment. A lens apparatus 200a and a lens apparatus 200b have a configuration similar to that of the above-described lens apparatus 200, and an imaging apparatus 300a and an imaging apparatus 300b have a configuration similar to that of the above-described imaging apparatus 300.

According to the present embodiment, the imaging apparatuses 300a and 300b are arranged back to back. Here, “back to back” means that directions from an incident side to an output side of the respective imaging apparatus 300a and imaging apparatus 300b are opposite each other. With this arrangement, it is possible to capture an image over a wide range that covers a 360° range using the image-pickup areas of the two imaging apparatuses.

The arrangement of the imaging apparatuses is merely an example and is not limited thereto. For example, the two imaging apparatuses can be arranged side by side to capture images in the same direction. In a case of this arrangement, a plurality of imaging apparatuses form a plurality of images each having parallax and thus can perform three-dimensional compound eye imaging such as virtual reality (VR) imaging and mixed reality (MR) imaging.

In the imaging system having the configuration as illustrated in FIG. 17, the imaging apparatus 300a has the image-pickup area 400a, the first range 401a, and the second range 402a, and the imaging apparatus 300b has the image-pickup area 400b, the first range 401b, and the second range 402b. At this time, the imaging apparatuses 300a and 300b are arranged back to back, so that the first range 401a overlaps with the second range 402b, and the first range 401b overlaps with the second range 402a. In other words, in the range with the angle of view of 88° to 92° in the image-pickup area of the imaging apparatus, the imaging apparatuses 300a and 300b each captures an image in an overlapping range. In the present specification, the range where the image-pickup areas of the plurality of imaging apparatuses overlap as described above may be simply referred to as an overlapping range.

When there is a difference in the imaging conditions of each imaging apparatus in compound eye imaging, it may be an obstacle in combining a plurality of images captured by each imaging apparatus into a single image. The imaging conditions of each imaging apparatus include, for example, a focus position shift due to a shift in focusing, a brightness setting in imaging, a white balance setting in correction, and the like. To equalize the imaging conditions among the imaging apparatuses, a method for cooperatively controlling a plurality of imaging apparatuses can be employed. However, in one embodiment, this method requires each imaging apparatus to support cooperative control, and coordination and communication control put a strain on processing of the imaging apparatus. Alternatively, a method can also be considered in which each imaging apparatus is connected to each other by wire to equalize the imaging conditions of each imaging apparatus, but the configuration of the imaging system can be complex for wired connection.

This issue can be solved by utilizing imaging information of the above-described overlapping range, that is, either one of the first range 401 and the second range 402 in each processing in the imaging system, which will be described below.

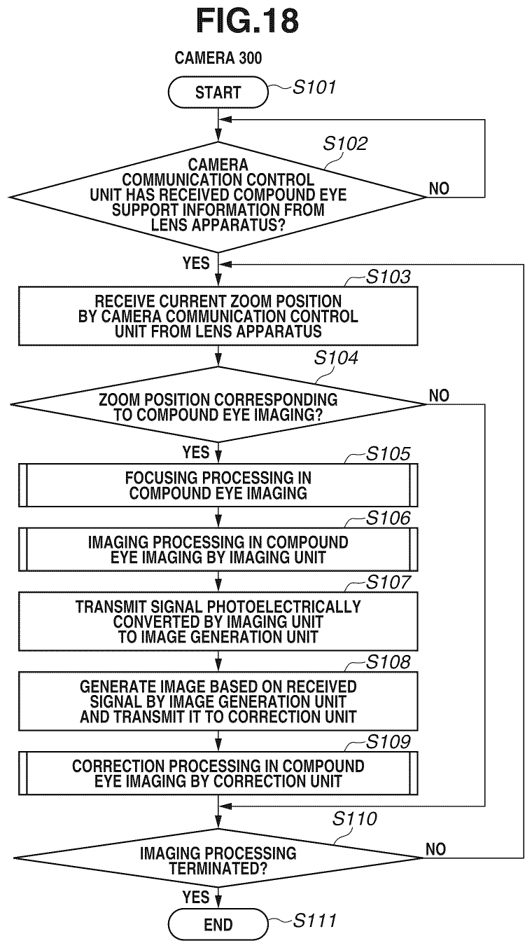

FIG. 18 is a flowchart illustrating a series of imaging processing in the imaging system according to the present embodiment.

In step S101, the processing is started and then proceeds to step S102.

In step S102, in a case where the camera communication control unit 305 receives the compound eye support information transmitted from the lens apparatus 200 (YES in step S102), the processing proceeds to step S103, and if not (NO in step S102), the processing returns to step S102.

In step S103, the camera communication control unit 305 receives the current zoom position from the lens apparatus 200, and the processing proceeds to step S104.

In step S104, it is determined whether the current zoom position corresponds to compound eye imaging, from the compound eye support information. In a case where the current zoom position corresponds to compound eye imaging (YES in step S104), the processing proceeds to step S105. In a case where the current zoom position does not correspond to compound eye imaging (NO in step S104), the processing proceeds to step S110.

In step S105, focusing processing in compound eye imaging is performed, and the processing proceeds to step S106.

In step S106, the imaging unit 303 performs imaging processing in compound eye imaging, and the processing proceeds to step S107.

In step S107, the signal photoelectrically converted by the imaging unit 303 is transmitted to the image generation unit 306, and the processing proceeds to step S108.

In step S108, the image generation unit 306 generates an image based on the received signal and transmits the image to the correction unit 307, and the processing proceeds to step S109.

In step S109, the correction unit 307 performs correction processing in compound eye imaging, and the processing proceeds to step S110.

In step S110, in a case where imaging processing is terminated (YES in step S110), the processing proceeds to Sill and is terminated. Whereas in a case where imaging processing is not terminated (NO in step S110), the processing returns to step S103. A case where imaging processing is terminated is, for example, a case where the power of the lens apparatus 200 is turned off.

Next, specific contents of each processing in compound eye imaging performed in steps S105, S106, and S109 will be described.

A first focusing processing method in compound eye imaging performed in step S105 will be described. The first focusing processing method does not determine a focus position for the entire image-pickup area 400, but determines the focus position by limiting only for the first range 401 and the second range 402. The camera CPU 304 determines the focus position in the range on the imaging element corresponding to the first range 401 or the second range 402, and transmits a focus drive command to the lens apparatus 200. The lens apparatus 200 causes the focus driving unit 204 to drive the focus lens based on the focus drive command received from the camera CPU 304.

By determining the focus position by referring to the overlapping imaging range in compound eye imaging as in the present method, the same imaging conditions can be determined without cooperatively controlling a plurality of the imaging apparatuses, so that it is possible to appropriately perform focusing while simplifying the imaging system.

Next, a second focusing processing method in compound eye imaging performed in step S105 will be described. Compared with the first method, the present method limits the range to be used in the first range 401 and the second range 402, so that it is possible to realize more appropriate focusing.

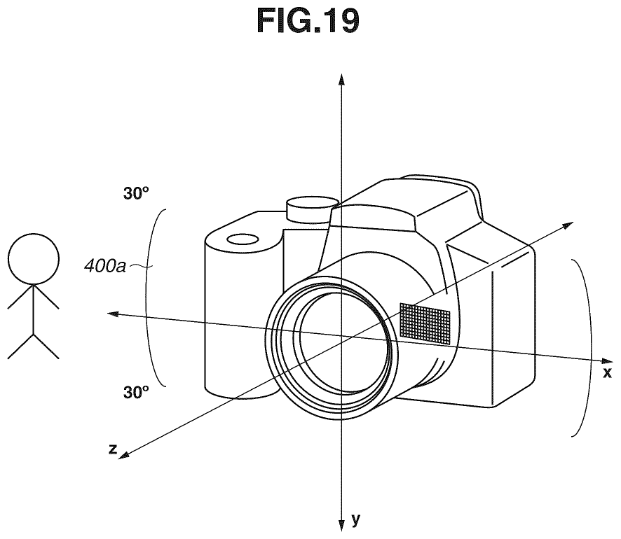

FIG. 19 is a schematic diagram of the second focusing processing method. In FIG. 19, with respect to the imaging apparatus set in a normal position with its bottom surface parallel to the ground, an axis horizontal to the optical axis direction is an x-axis, an axis perpendicular to the optical axis direction is a y-axis, and an axis parallel to the optical axis direction is a z-axis. In this case, as illustrated in FIG. 19, it is typically considered that an object to be focused is present in a direction horizontal to the imaging apparatus. In other words, by determining the focus position by limiting the direction not to the direction perpendicular to the y-axis, but to the direction perpendicular to the x-axis, it is possible to eliminate a range in which it is unlikely that the object is in focus in any imaging apparatus. Thus, the focus position is further limited from the first range 401 and the second range 402 and is determined within a specific angle from the x-axis, for example, within an angle of 30° above and below as illustrated in FIG. 19.

In the above-described method, the range to be limited is uniquely set, but the imaging apparatus can also be equipped with an operation unit such as a switcher to enable a user to arbitrarily set the range to be limited. For example, in one embodiment, the imaging apparatus 300a is limited only to the end range of the angle of view on the left side surface, and the imaging apparatus 300b is limited only to the end range of the angle of view on the right side surface, so that the overlapping range to be used is further limited, and it is possible to eliminate a range in which it is unlikely that the object is in focus in each imaging apparatus.

As in the present method, it is possible to perform appropriate focusing while simplifying the imaging system by determining the focus position by referring to the overlapping range in compound eye imaging and further limiting to a range in which an object is likely to be present.

Next, a first imaging processing method in compound eye imaging in step S106 will be described.

In the first imaging processing method, in one embodiment, the imaging conditions are not determined for the entire image-pickup area 400 but are determined by limiting only for the first range 401 or the second range 402. Here, the imaging conditions are brightness and imaging sensitivity. The camera CPU 304 sets the imaging sensitivity of the imaging unit 303 based on the brightness determined on the range on the imaging element corresponding to the first range 401 and the second range 402 and captures an image.

As in the present method, it is possible to perform appropriate imaging processing while simplifying the imaging system by determining the brightness and imaging sensitivity by referring to the overlapping range in compound eye imaging.

Next, a second imaging processing method in compound eye imaging in step S106 will be described.

In the present method, the range used in the first range 401 and the second range 402 is more limited compared with the first imaging processing method, and it is thereby possible to realize more appropriate brightness and imaging sensitivity setting.

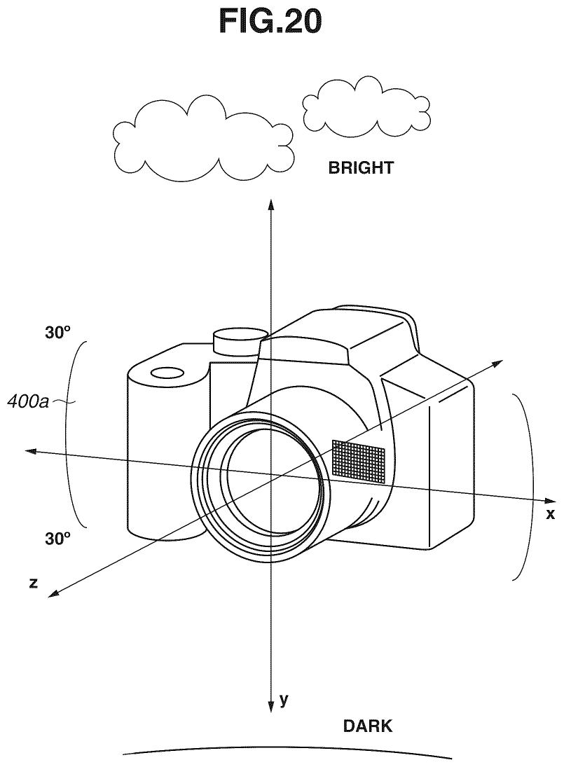

In FIG. 20, as in FIG. 19, with respect to the imaging apparatus set in the normal position with its bottom surface parallel to the ground, the axis horizontal to the optical axis direction is the x-axis, the axis perpendicular to the optical axis direction is the y-axis, and the axis parallel to the optical axis direction is the z-axis. At this time, as illustrated in FIG. 20, an upper side of the imaging apparatus is bright due to the sky or illumination, and a lower side thereof is dark due to the ground. In other words, by determining the brightness and imaging sensitivity by limiting the direction not to the direction perpendicular to the y-axis, but to the direction perpendicular to the x-axis, it is possible to appropriately set the brightness for any imaging apparatus.

For example, the brightness and imaging sensitivity are determined by further limiting the range from the first range 401 and the second range 402 to within a specific angle from the x-axis, for example, an angle of 30° above and below as illustrated in FIG. 20.

As in the present method, by determining the brightness and imaging sensitivity by referring to the overlapping range in compound eye imaging and further limiting it to an appropriate range, it is possible to perform appropriate imaging processing while simplifying the imaging system.

Next, a correction processing method in compound eye imaging in step S109 will be described.

In the correction processing method according to the present embodiment, the white balance is not determined for the entire image-pickup area 400, but is determined by limiting only for the range on the imaging element corresponding to the first range 401 and the second range 402, which are the overlapping ranges. The camera CPU 304 sets and corrects the white balance of the correction unit 307 based on the white balance determined in the first range 401 and the second range 402.

As in the present method, by determining the white balance by referring to the overlapping range in compound eye imaging, it is possible to perform appropriate imaging processing while simplifying the imaging system.

As described above, it is possible to provide an imaging system and a lens apparatus that can simplify the imaging system in compound eye imaging by any method.

The exemplary embodiments and examples according to the present disclosure are described above, but the present disclosure is not limited to these embodiments and examples, and various combinations, modifications, and variations can be made within the spirit and scope of the disclosure.

According to the present embodiment, the imaging apparatus determines an angle of view based on the current zoom position and performs various processing based on the angle of view, but the present disclosure is not limited to this configuration and may determine the angle of view by transmitting and receiving information about the angle of view.

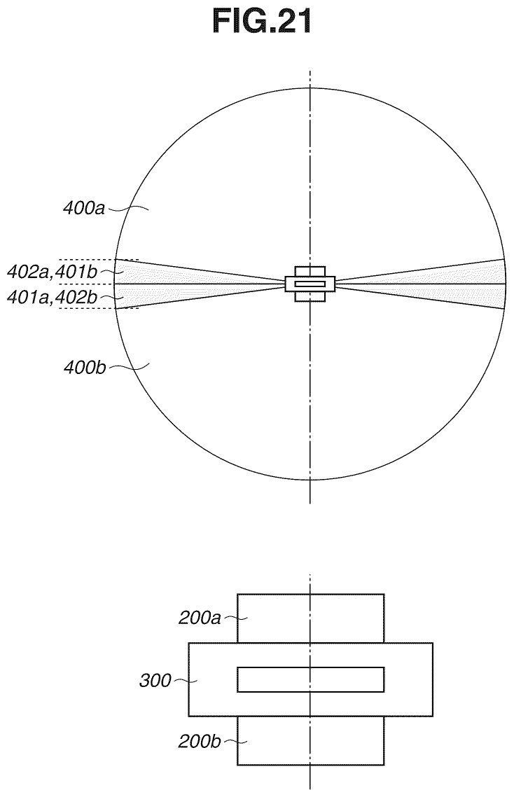

According to the present embodiment, two imaging apparatuses are used in the imaging system, but the present disclosure is not limited to this configuration. For example, as illustrated in a modification in FIG. 21, a plurality of the lens apparatuses 200a and 200b can be attached to a common imaging apparatus 300. In this case, the imaging element that receives light from each lens apparatus can be common to the lens apparatuses 200a and 200b, or different imaging elements can also be provided for each.

According to the present embodiment, a plurality of the imaging apparatuses 300a and 300b is arranged back to back to capture images in opposite directions, but the present disclosure is not limited to this configuration. For example, a plurality of lens apparatuses can be arranged side by side. Here, “side by side” means that the imaging apparatuses 300a and 300b are arranged next to each other so that their directions from the incident side to the output side face the same direction. With this arrangement, compound eye imaging such as VR imaging and MR imaging can be performed.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-181943, filed Oct. 17, 2024, which is hereby incorporated by reference herein in its entirety.

What is claimed is:

1. A system comprising:
a first lens apparatus and a second lens apparatus each having a half angle of view exceeding 90° corresponding to a maximum image height in focusing at infinity at a wide-angle end; and
a first imaging apparatus that includes a first element configured to receive light of an image formed by the first lens apparatus,
wherein the system includes an overlapping range where image-pickup areas of the first lens apparatus and the second lens apparatus overlap with each other, and
wherein the first imaging apparatus determines a condition of the first imaging apparatus based on information in the overlapping range.

2. The system according to claim 1, wherein the information and the condition include at least one of brightness, sensitivity, white balance, or a focus position.

3. The system according to claim 2,
wherein the first lens apparatus includes a first communication unit configured to communicate with the first imaging apparatus,
wherein the first imaging apparatus includes a second communication unit configured to communicate with the first lens apparatus,
wherein the first communication unit transmits information about a zoom position of the first lens apparatus to the first imaging apparatus, and
wherein the second communication unit receives the information about the zoom position from the first lens apparatus.

4. The system according to claim 3, wherein the first imaging apparatus determines the condition based on the information about the zoom position and the information in the overlapping range.

5. The system according to claim 4,
wherein the first imaging apparatus includes a correction unit configured to correct an image generated based on a signal output from the first element, and
wherein the correction unit determines white balance of the first imaging apparatus based on white balance in the overlapping range.

6. The system according to claim 5, further comprising a generation unit configured to generate an image based on a signal output from the first element.

7. The system according to claim 4,
wherein the first communication unit transmits information about an angle of view of the first lens apparatus to the first imaging apparatus, and
wherein the second communication unit receives the information about the angle of view from the first lens apparatus.

8. The system according to claim 4, further comprising a second imaging apparatus that includes a second element configured to receive light of an image formed by the second lens apparatus,
wherein the second imaging apparatus determines a condition based on information in the overlapping range.

9. The system according to claim 1, wherein the first lens apparatus and the second lens apparatus are arranged such that a direction from an incident side to an output side of the first lens apparatus and a direction from an incident side to an output side of the second lens apparatus are opposite to each other.

10. A lens apparatus that is applicable to the system according to claim 1, the lens apparatus comprising:
a first lens unit having a negative refractive power arranged in order from an object side to an image side; and
a rear unit including one or more lens units and having a positive refractive power as a whole,
wherein a distance between adjacent lens units changes in zooming, and
wherein a focusing unit that includes one or a plurality of lens units included in the rear unit moves in an optical axis direction in focusing.

11. The lens apparatus according to claim 10, wherein a following conditional expression is satisfied:
$$- 3. < fL 1 / fw < - 1.7 ,$$
where fL1 is a focal length of the first lens unit, and fw is a focal length of the lens apparatus at a wide-angle end.

12. The lens apparatus according to claim 10,
wherein the rear unit includes a second lens unit having a negative refractive power, and
wherein a following conditional expression is satisfied:
$$- 5. < \vert fL 2 \vert / fL 1 < - 1.1 ,$$
where fL2 is a focal length of the second lens unit, and fL1 is a focal length of the first lens unit.

13. The lens apparatus according to claim 10, wherein a following conditional expression is satisfied:
$$1.4 < fG 1 / fL 1 < 3. ,$$
where fG1 is a focal length of a lens G1 arranged closest to the object in the first lens unit, and fL1 is a focal length of the first lens unit.

14. The lens apparatus according to claim 10, wherein a following conditional expression is satisfied:
$$0.4 < fG 1 / fG 2 < 1.6 ,$$
where fG1 is a focal length of a lens G1 arranged closest to the object in the first lens unit, and fG2 is a focal length of a lens G2 arranged adjacent to the image side of the lens G1.

15. The lens apparatus according to claim 10, wherein a following conditional expression is satisfied:
$$3.5 < fLF / fw < 15. ,$$
where fLF is a focal length of the focusing unit, and fw is a focal length of the lens apparatus at a wide-angle end.

16. The lens apparatus according to claim 10, wherein a following conditional expression is satisfied:
$$- 4.1 < fLF / fL 1 < - 1.8 ,$$
where fLF is a focal length of the focusing unit, and fL1 is a focal length of the first lens unit.

17. The lens apparatus according to claim 10, wherein a following conditional expression is satisfied:
$$- 1.3 < fL 1 / fLRw < - 0.55 ,$$
where fL1 is a focal length of the first lens unit, and fLRw is a focal length of the rear unit at a wide-angle end.

18. The lens apparatus according to claim 10, wherein a following conditional expression is satisfied:
$$2. < Skw / fw < 6. ,$$
where Skw is a back focal length at a wide-angle end, and fw is a focal length of the lens apparatus at the wide-angle end.

19. The lens apparatus according to claim 10,
wherein the rear unit includes an aperture stop, and
wherein a following conditional expression is satisfied:
$$0.4 < DSPw / Skw < 1. ,$$
where DSPw is a distance on an optical axis from the aperture stop in an entire system of the lens apparatus at a wide-angle end to a lens surface closest to the image, and Skw is a back focal length at the wide-angle end.

20. The lens apparatus according to claim 10, wherein a following conditional expression is satisfied:
$$1.65 < ndG 1 < 2.2 ,$$
where ndG1 is a refractive index with respect to a d-line of a material of a lens G1 arranged closest to the object in the first lens unit.

21. The lens apparatus according to claim 10,
wherein a lens G1 arranged closest to the object in the first lens unit has a negative refractive power and is a meniscus lens that has a convex surface facing the object side, and
wherein a following conditional expression is satisfied:
$$1.3 < ( R 1 + R 2 ) / ( R 1 - R 2 ) < 3. ,$$
where R1 is a curvature radius of an object side lens surface of the lens G1, and R2 is a curvature radius of an image side lens surface of the lens G1.

22. The lens apparatus according to claim 10, wherein a following conditional expression is satisfied:
$$1.5 < Yta / Ywa < 3. ,$$
where Yta is a maximum image height at a telephoto end, and Ywa is a maximum image height at a wide-angle end.

23. The lens apparatus according to claim 10, further comprising a first lens barrel configured to hold the first lens unit,
wherein a lens G1 closest to the object in the first lens unit has a meniscus shape with its convex surface facing the object side, and
wherein a surface vertex on the object side of the lens G1 is located closer to the object than the first lens barrel.

24. An apparatus comprising:
a lens apparatus having a half angle of view exceeding 90° corresponding to a maximum image height in focusing at infinity at a wide-angle end; and
an element configured to receive light of an image formed by the lens apparatus,
wherein, in a case where a range where a half angle of view corresponding to a maximum image height in focusing at infinity at a wide-angle end exceeds 90° in a range of the element corresponding to an image-pickup areas of the lens apparatus is defined as a first range, a condition is determined based on information in the first range.
